(19) United States
(12) Patent Application Publication
(10) Pub. No.: US 2024/0429549 A1
(43) Pub. Date: Dec. 26, 2024

(54) Housing for Storing Batteries

(71) Applicant: BTS Netherlands B.V., Steenwijk (NL)

(72) Inventors: Nick Akkerman, Steenwijk (NL); Marco Paardekooper, Steenwijk (NL); Dick Van De Steeg, Steenwijk (NL); Rene Van Wijngaarden, Steenwijk (NL)

(21) Appl. No.: 18/570,680

(22) PCT Filed: Jun. 14, 2022
(86) PCT No.: PCT/NL2022/050333

§ 371 Date: Dec. 15, 2023

(30) Foreign Application Priority Data
Jun. 16, 2021 (NL) 2028461

(51) Int. Cl. H01M 50/383; H01M 10/0525; H01M 10/46; H01M 50/333; H01M 50/358

(52) U.S. Cl. CPC H01M 50/383; H01M 10/0525; H01M 10/46; H01M 50/333; H01M 50/358

(57) ABSTRACT

The invention relates to a housing for storing batteries, particularly lithium-ion batteries, which housing includes a closable, first chamber for containing batteries; and a second chamber arranged adjacently of the first chamber. The closable, first chamber includes an access door and includes a discharge opening arranged in the wall of the first chamber, in which discharge opening a pressure-relief valve is arranged.

### CROSS REFERENCE TO RELATED APPLICATIONS

This application is the United States national phase of International Patent Application No. PCT/NL2022/050333 filed Jun. 14, 2022, and claims priority to The Netherlands Patent Application No. 2028461 filed Jun. 16, 2021, the disclosures of which are hereby incorporated by reference in their entireties.

### BACKGROUND OF THE INVENTION

### Field of the Invention

The invention relates to a housing for storing batteries, particularly lithium-ion batteries. Such a housing is for instance known from CN 107947296.

### Description of Related Art

CN 107947296 describes a housing which is provided with various drawers in which batteries can be placed. Each drawer can be locked in shut position. Further provided in the drawer are extinguishing means for extinguishing any fire. Provided on the rear side of the drawer is a discharge pipe along which extinguishing agent or flue gases can be discharged.

However, when a lithium-ion battery spontaneously combusts, for instance due to short-circuiting or damage, such a battery can no longer be extinguished as a result of the chemical reaction taking place in the battery. In the housing according to CN 107947296 a lithium-ion battery placed therein will keep burning despite the presence of extinguishers. A combusted lithium-ion battery may also cause other batteries to combust, which could cause the flames to spread out of the discharge pipe, which entails further risks.

The various drawers of the housing according to CN 107947296 are here placed in the same chamber, whereby hot combustion gases can easily spread throughout the housing.

Nowadays, lithium-ion batteries are used in diverse appliances and particularly in electric bicycles. Such batteries are charged frequently, and every charging cycle entails a risk of the lithium-ion battery spontaneously combusting. Since this charging usually takes place in people's homes, it is desirable that this charging can take place safely.

### SUMMARY OF THE INVENTION

It is now an object of the invention to reduce or even obviate the above stated drawbacks.

This object is achieved according to the invention by a housing, comprising:
a closable, first chamber for containing batteries; and
a second chamber arranged adjacently of the first chamber

wherein the closable, first chamber comprises an access door and comprises a discharge opening arranged in the wall of the first chamber, in which discharge opening a pressure-relief valve is arranged.

Because the first chamber is closable, the flames can be kept inside the first chamber in the event of a lithium-ion battery combusting. A pressure-relief valve is further provided to prevent the pressure in the first chamber from becoming too high as a result of the created flue gases. The pressure-relief valve here ensures that supply of oxygen to the first chamber is prevented and ensures that any flames will be unable to spread outside via the discharge opening.

The second chamber is provided to store accessories, such as for instance a charger, with a combustion risk which is many times lower. The first chamber can hereby be used for components forming a fire hazard, and the second chamber can be used for other components.

In a preferred embodiment of the housing according to the invention the first chamber comprises a cylindrical wall and a first end wall, which first end wall closes the cylindrical wall at one outer end, and wherein the access door is arranged at the other outer end and closes this other outer end.

The cylindrical wall imparts to the housing a good strength which is well able to withstand increased pressures. In the event that a battery combusts, it will hereby be possible for the housing to withstand pressure variations in simple manner. The pressure-relief valve will here ensure that the pressure on the housing does not become too high.

In another embodiment of the housing according to the invention a first seal, such as a cellular rubber, is arranged along the periphery of the access door.

The first seal provides for a good sealing of the first chamber and additionally provides the option of guiding a power cable past door without the access door having to be held open for this purpose. It is hereby possible to still safely store a lithium-ion battery, with a charger arranged in the second chamber, in the first chamber while the battery is being charged.

In a further embodiment of the housing according to the invention a second seal, such as a cellular rubber, is arranged along the periphery of the cylindrical wall at the other outer end.

The access door can be sealed relative to the housing by either the first seal or the second seal, or by the combination of the first and second seal.

When applying both the first and the second seal, it is possible to guide thicker power cables past the access door, without the tightness of the first chamber being adversely affected.

In a further embodiment of the housing according to the invention the housing further comprises a frame on which the first chamber is arranged and wherein a drawer which can be slid into and out of the frame forms the second chamber.

In another preferred embodiment of the housing according to the invention the housing further comprises a flue gas discharge channel, which flue gas discharge channel connects to the discharge opening.

In order to ensure that the flue gases do not find their way into an accommodation in the event of a battery combusting in the first chamber of the housing, the housing can be provided with a flue gas discharge channel for discharging the flue gases to a desired location, such as into the outside air.

In yet another preferred embodiment of the housing according to the invention the pressure-relief valve is a spring-loaded pressure-relief valve.

With a spring-mounted pressure-relief valve the desired threshold for the overpressure can be set in simple manner by adjusting the spring force. In addition, the spring-relief valve will also close again as soon as the pressure in the housing has normalized.

The invention further relates to a combination of a lithium-ion battery, a battery charger with a charging cable and a housing according to the invention, wherein the lithium-ion battery is accommodated in the first chamber, wherein the battery charger is accommodated in the second chamber, and wherein the charging cable runs from the second chamber to the first chamber and is connected to the lithium-ion battery.

The charging cable preferably runs past the access door.

These and other features according to the invention are further elucidated with reference to the accompanying drawings.

### BRIEF DESCRIPTION OF THE DRAWINGS

The terms Fig., Figs., Figure, and Figures are used interchangeably in the specification to refer to the corresponding figures in the drawings.

FIG. 1 shows a perspective view of an embodiment of a housing according to the invention.

FIG. 2 shows a cross-sectional view of the housing according to FIG. 1 with a battery and charger therein.

### DESCRIPTION OF THE DRAWINGS

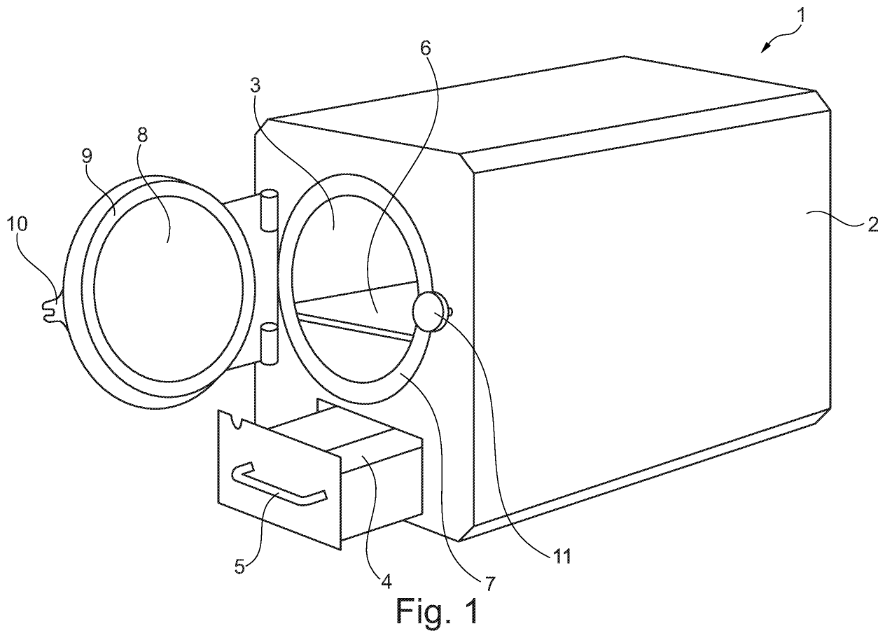

FIG. 1 shows a housing 1 with a frame 2 in which a first chamber 3 and a second chamber 4 are arranged. The second chamber 4 is embodied as a drawer with a handle 5. Provided in first chamber 3 is a shelf 6.

Provided around the access opening of the first chamber 3 is a seal 7 of cellular rubber. An access door 8 on which a seal of cellular rubber 9 is likewise arranged can be pivoted against the access opening and the first chamber 3 can be closed airtightly by means of a closure 10, 11.

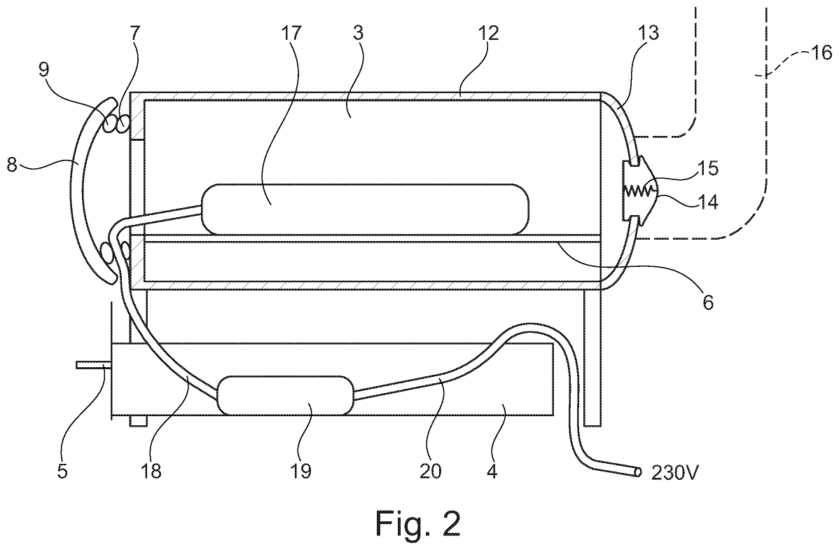

As shown in FIG. 2, first chamber 3 is formed by a cylindrical wall 12 which is closed at one end with a rear wall 13 and can be closed airtightly at the other end by means of the access door 8.

Arranged in rear wall 13 is a pressure-relief valve 14 which is under load of a spring 15. The pressure-relief valve 14 can be connected to a flue gas discharge channel 16 for discharging blown-off flue gases.

In first chamber 3 a lithium-ion battery 17 is placed on shelf 6 and connected via a charging cable 18 to a charger 19, which is powered with a mains lead 20. Because two seals 7, 9 are provided between access door 8, charging cable 18 can be guided outside from the battery 17 without the tightness of first chamber 3 being adversely affected.

1. A housing for storing batteries, particularly lithium-ion batteries, which housing comprises:
a closable, first chamber for containing batteries; and
a second chamber arranged adjacently of the first chamber
wherein the closable, first chamber comprises an access door and comprises a discharge opening arranged in the wall of the first chamber, in which discharge opening a pressure-relief valve is arranged.

2. The housing according to claim 1, wherein the first chamber comprises a cylindrical wall and a first end wall, which first end wall closes the cylindrical wall at one outer end, and wherein the access door is arranged at the other outer end and closes this other outer end.

3. The housing according to claim 2, wherein a first seal, such as a cellular rubber, is arranged along the periphery of the access door.

4. The housing according to claim 2, wherein a second seal, such as a cellular rubber, is arranged along the periphery of the cylindrical wall at the other outer end.

5. The housing according to claim 1, wherein the housing further comprises a frame on which the first chamber is arranged and wherein a drawer which can be slid into and out of the frame forms the second chamber.

6. The housing according to claim 1, wherein the housing further comprises a flue gas discharge channel, which flue gas discharge channel connects to the discharge opening.

7. The housing according to claim 1, wherein the pressure-relief valve is a spring-loaded pressure-relief valve.

8. A combination of a lithium-ion battery, a battery charger with a charging cable and a housing according to claim 1, wherein the lithium-ion battery is accommodated in the first chamber, wherein the battery charger is accommodated in the second chamber, and wherein the charging cable runs from the second chamber to the first chamber and is connected to the lithium-ion battery.

9. The combination according to claim 8, wherein the charging cable runs past the access door.
